(19) United States
(12) Patent Application Publication
(10) Pub. No.: US 2002/0041574 A1
(43) Pub. Date: Apr. 11, 2002

(54) Multiplexing and / or demultiplexing apparatus

(76) Inventors: Keming Du, Aachen (DE); Peter Loosen, Aachen (DE); Reinhart Poprawe, Aachen (DE)

Correspondence Address: MILDE, HOFFBERG & MACKLIN, LLP, SUITE 460, 10 BANK STREET, WHITE PLAINS, NY, 10606, US

(21) Appl. No.: 09/850,761

(22) Filed: Jul. 16, 2001

(30) Foreign Application Priority Data
May 8, 2000 (DE) 100 22 249.8

(51) Int. Cl. H04J 14/06

(52) U.S. Cl. 370/300; 359/127; 359/122

(57) ABSTRACT

In apparatus for multiplexing and/or demultiplexing at least two electromagnetic waves of different wavelengths λ₁, λ₂, the improvement comprising at least one polarizing element wherein, the waves enter into said element in a linearly polarized manner.

The present invention relates to an arrangement for multiplexing and/or demultiplexing at least two electromagnetic waves of different wavelengths λ₁, λ₂.

In the field of optical telecommunications the highest data rate is 40 Gbits/s per channel at the moment. A further increase in the data rate is achieved by WDM (wavelength division multiplexing) and DWDM (dense wavelength division multiplexing). Data are here simultaneously transmitted with several channels of different wavelengths over one fiber; the data rate is directly increased by the number of channels. The wavelength window used at the moment is in the range of 1530 nm to 1565 nm. The presently available wavelength pitch is 1.6 nm. This results in 16 channels. For the two above-mentioned methods WDM and DWDM, mainly three components are used with corresponding applications:

thin dielectric filters: they are mostly used in DWDM systems with a wavelength pitch of 1.6 nm to 3.2 nm. However, the problem with thin dielectric film filters is that it is difficult to reduce the wavelength pitch;

planar waveguides (and arrays composed thereof): they consist of several layers applied to silicon or silicate with great care. The layers are structured with the methods used for the production of ICs, such as photolithography and ion etching. The planar waveguides are sensitive to changes in temperature. Their function is normally stabilized by heating above ambient temperature. The drawback of such planar waveguides is that their loss is relatively high;

fiber-based arrangements: these are e.g. fibers with long and short periodic gratings, or in a Mach-Zehnder configuration. Such DWDM arrangements are highly operative. Recently, a wavelength pitch of 0.04 nm could be achieved.

In the field of high-power diode lasers, wavelength multiplexing is also used with thin film filters for increasing the radiation density. Until recently the use of high-power diode lasers in material treatment was limited to the pumping of solid-state lasers because of the inadequate beam quality and power density. Recently, due to the increase in the output power and the development of cooling and mounting techniques, high-power diode laser systems have now been used for direct material treatment for the first time.

At the moment a considerable power scaling is achieved by linearly arranging individual emitters side by side to form laser bars and by stacking said bars to obtain so-called stacks. The focusing characteristics of the radiation deteriorate because of such a spatial arrangement.

A spectral superposition of several diode laser wavelengths and the polarization coupling of differently polarized diode lasers of one wavelength would permit an increase in power with a beam quality that is almost maintained.

Thin films are used for wavelength multiplexing and for enhancing the radiation density of high-power diode lasers. With such an application, the power efficiency is of central importance. The typical edge steepness is 0.03/nm to 0.05/nm. The wavelengths of high-power diode lasers are in the range of 800 nm to 1000 nm. For a power efficiency higher than 90%, a total of 5 to 10 wavelengths can be coaxially superposed with thin film filters.

The use of other methods, for instance planar waveguides and fiber arrangements, is limited by thermal loadability.

An optical arrangement according to the prior art for wavelength coupling is shown in FIG. 9. Such an arrangement comprises a plurality of diode lasers 100, each emitting radiation at the wavelengths λ₁, λ₂, λ₃ and λ₄. The respective radiation portions impinge on optical filters at a respective angle of 45°, the first optical filter being highly reflective for the radiation of wavelength λ₁ (filter HR), while the further filters (KF1, KF2, KF3) are highly reflective for the radiation to be respectively coupled in and the wavelength thereof, and the filters being highly transmitting on a broad band for the radiation portions and wavelengths of the respectively preceding sources of radiation. A joint output beam, which is designated by 101, is thereby obtained.

Starting from an arrangement having the above-indicated features and in consideration of the above-described prior art, it is the object of the present invention to provide an arrangement which is used for multiplexing and/or demultiplexing at least two electromagnetic waves of different wavelengths λ₁, λ₂ and which, in comparison with known arrangements, is efficiency-enhancing, in particular in cases where the difference in wavelength is small.

This object is achieved by an arrangement for multiplexing and/or demultiplexing at least two electromagnetic waves of different wavelengths λ₁, λ₂, said arrangement being characterized in that at least one polarizing element is used, with the waves entering into the element in a linearly polarized manner.

According to the invention polarized elements, such as polarization beam splitters (also abbreviated in this description as PBS), double-refractive beam displacers as well as wave plates (also designated in this description as PR), are used for multiplexing or for multiplexing and/or demultiplexing. The respective polarizing element is dimensioned such that with respect to the two polarizations the relative phase delay of the same wavelength is n times half the wavelength. The factor n is an integer and depends on the respective wavelength. Depending on the wavelength, the polarization after the polarizing element is rotated by 90° or not influenced. Thus the polarization of different wavelengths can be selectively adjusted, and the radiation of different wavelengths can be coaxially superposed or separated, for instance, by means of a polarization beam splitter or a beam displacer. A beam displacer is here a double-refractive element; within said element, the differently polarized elements propagate because of a so-called walk-off effect in different directions. After passage through the element a lateral offset is created between the two polarizations. Radiations of a different polarization are thus spatially separated.

Applications of the arrangement according to the invention are:

WDM and DWDM for optical telecommunications, optical fiber communications

coaxial superposition of the radiation of high-power diode lasers of different wavelengths for increasing the radiation density

coaxial superposition of the radiation of high-power diode lasers of a low order for pumping Raman amplifiers or lasers

separation (division) of wavelengths

selection and filtering of wavelengths.

As for randomly or statistic polarized waves, the waves are divided by a polarizer into two linearly polarized waves before entering into the element. A beam displacer (BD) or a polarization beam divider (PBS) may be used for the division.

The polarizer or the beam displacer may, as indicated above, be designed in the form of a waveguide, in particular in the form of a planar waveguide. It is thereby possible to achieve a compact and integratable structure.

If the waves are elliptically polarized, the waves are transformed by a phase retarding plate into linearly polarized waves before entering into the element.

Alternatively, the elliptically polarized waves can be transformed by a rotator into linearly polarized waves before entering into the element.

The arrangement is particularly suited for optical radiation.

The polarizing elements may be formed by polarization beam splitters.

The polarizing elements may also be formed by beam displacers. This permits a simple realization of the arrangement without deflection.

For an integratable solution the respective electromagnetic wave may be guided by a waveguide to the element. In particular, the waveguide is here dimensioned and designed such that the wave has a defined polarization at the exit end of the waveguide.

Such a waveguide can be used with a periodic grating structure or with an interferometric structure for multiplexing or demultiplexing.

In a further preferred arrangement a phase retarding plate is used after the polarizing elements for changing the state of polarization of at least one of the waves having a defined wavelength, the polarization states of the other waves with other wavelengths being substantially unchanged. This arrangement has the effect that, after the phase retarding plate, waves of a different wavelength and different polarization are transformed into waves of the same linear polarization.

The arrangement described above may be constructed for 3 to n waves of different wavelengths λ₁, λ₂, λ₃, λ₄, . . . λₙ in N steps with polarizing elements arranged in cascade-like fashion one after the other, where

N=1+log₂ n for n≠2^{N}

and

n=log₂ n for n=2^{N}.

Furthermore, multiplexing and/or demultiplexing may be carried out by at least one additional spectral filter.

The multiplexing and/or demultiplexing methods with polarizing elements may also be combined with conventional multiplexing and/or demultiplexing methods, using e.g. thin layer filters, gratings with a periodic grating structure and arrayed waveguide gratings.

Multiplexing and/or demultiplexing may also be carried out with at least one additional arrayed waveguide grating (AWG), so that the advantages of different methods can be exploited in an optimum way.

Some basics of the invention will now be explained with reference to theoretical ideas:

A wave plate of a thickness w is considered. The refractive index of wavelength λ₁ is n_{1π} for a π-polarization and n_{1σ} for a σ-polarization. While passing through the wave plate of a thickness d, the two polarizations are each subjected to the following phase change:

Φ_{1π}=n_{1π}d (1)

Φ_{1σ}=n_{1σ}d (2)

The difference of the phase change is then:

ΔΦ₁=|n_{1π}−n_{1σ}|d (3)

When phase plates are used, the angle between the optical axis of the wave plates and the polarization direction is about 45°. A 90°-rotation of the polarization is achieved by adjusting the angle between the optical axis of the wave plates and the direction of polarization to 45° and by the difference in the phase changes amounting to N₁λ₁/2, where N₁ is an uneven integer. The polarization remains in fact unchanged if the difference of the phase change becomes N₁λ₁/2, where N₁ is an even integer. As for the above-mentioned changes in polarization, it follows for the wavelength λ₁:

$$\vert {n}_{1 π} - {n}_{1 σ} \vert = {N}_{1} \frac{{λ}_{1}}{2} \qquad ( 4 )$$

For wavelength λ₂:

$$\vert {n}_{2 π} - {n}_{2 σ} \vert = {N}_{2} \frac{{λ}_{2}}{2} \qquad ( 5 )$$

It is possible for a suitable dimensioning of the wave plate and in consideration of the dispersion to generate different integers N at different wavelengths. This means that the polarization of a different wavelength can be varied by selection of the material (dispersion) and the thickness d simultaneously, selectively and in a targeted manner.

For WDM and DWDM the wavelength is in the range of 1500 nm to 1600 nm. For a small wavelength window, the dispersion is neglected in the following discussion. It follows:

|n_{1π}−n_{1σ}|d=|n_{π}−n_{σ}|d=Δnd (6)

$$\begin{matrix}⇒ Δ n d = {N}_{1} \frac{{λ}_{1}}{2} & ( 7 ) \\ Δ n d = {N}_{2} \frac{{λ}_{2}}{2} & ( 8 )\end{matrix}$$

For the directly neighboring wavelengths it follows:

N₂=N₁+1 (9)

$${λ}_{2} = N \frac{{2}_{Δ nd}}{{N}_{1} + 1} \qquad ( 10 )$$

For the case N₁>1 it follows:

$$\begin{matrix}{λ}_{2} = {λ}_{1} ( 1 - \frac{1}{{N}_{1}} ) \\ and & ( 11 ) \\ Δ λ = \frac{{λ}_{1}}{{N}_{1}} & ( 12 )\end{matrix}$$

It generally follows for

Δ=N₁−N₂ (13)

$$Δ λ = \frac{{λ}_{1} Δ N}{{N}_{1}} \qquad ( 14 )$$

The wavelength of high-power diode lasers is in the range of 780 nm to 980 nm, so that the dispersion in this range of specific materials plays no essential role in this range either.

It is possible by suitably selecting the materials with respect to dispersion, double refraction and thickness that the wavelength pitches become approximately constant.

The above-discussed dependence of the polarization on the wavelength can be exploited for the above-mentioned possible applications.

Embodiments of the present invention shall now be explained with reference to the drawing, in which:

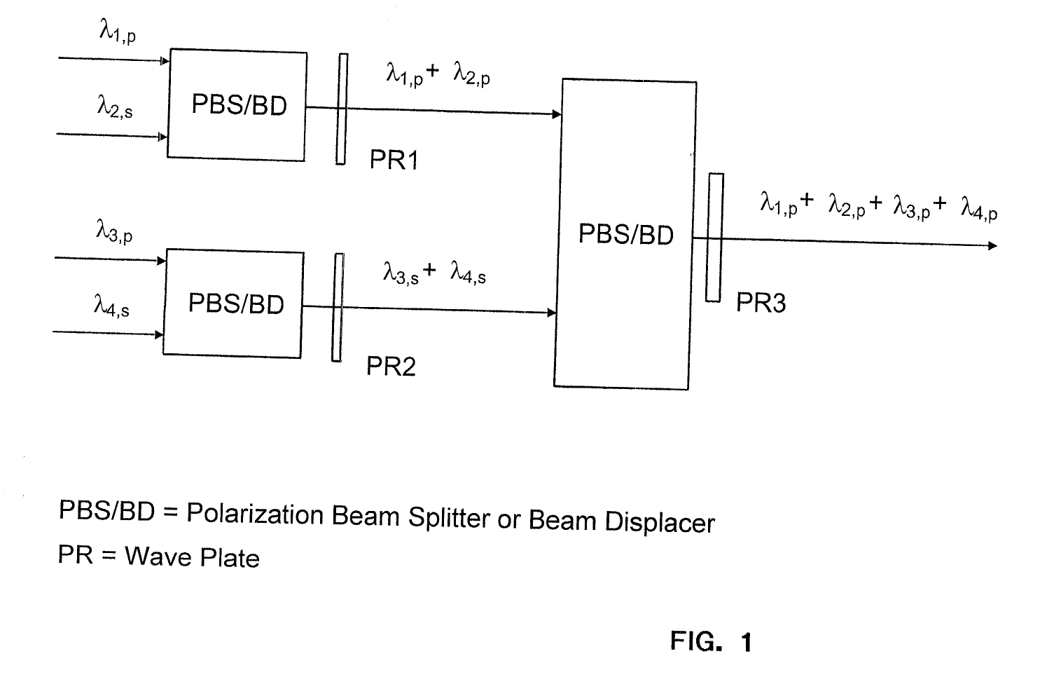

FIG. 1 shows an arrangement for wavelength multiplexing with four beams, each having a different wavelength, and having in each pair a different polarization to the other;

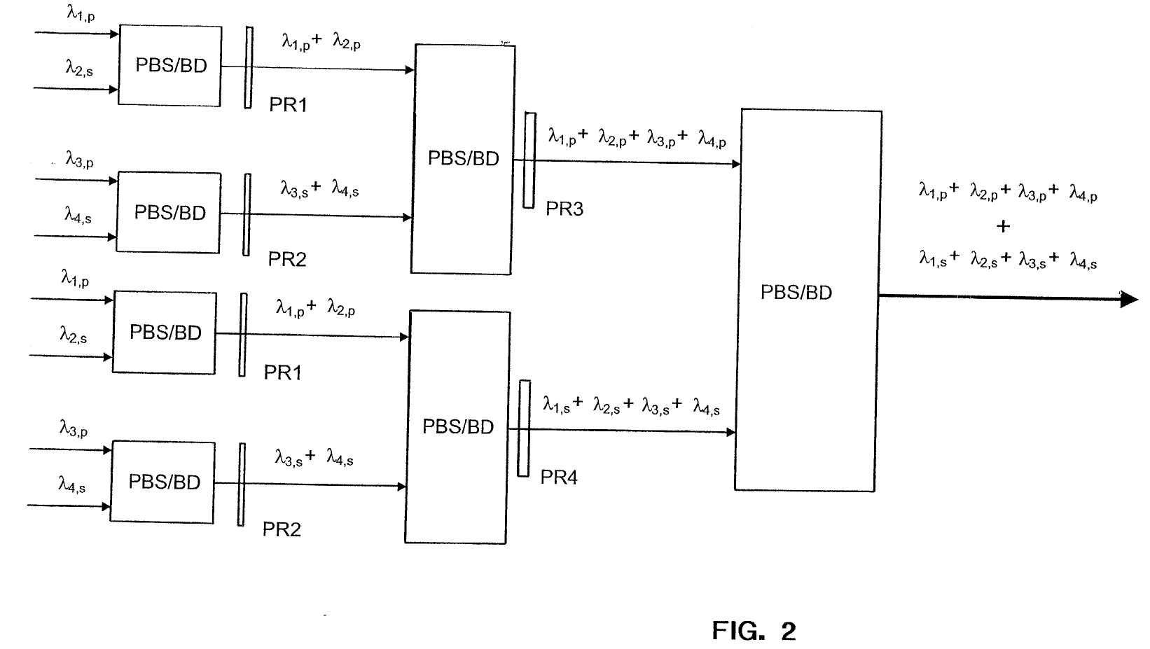

FIG. 2 shows an arrangement doubled in comparison with FIG. 1;

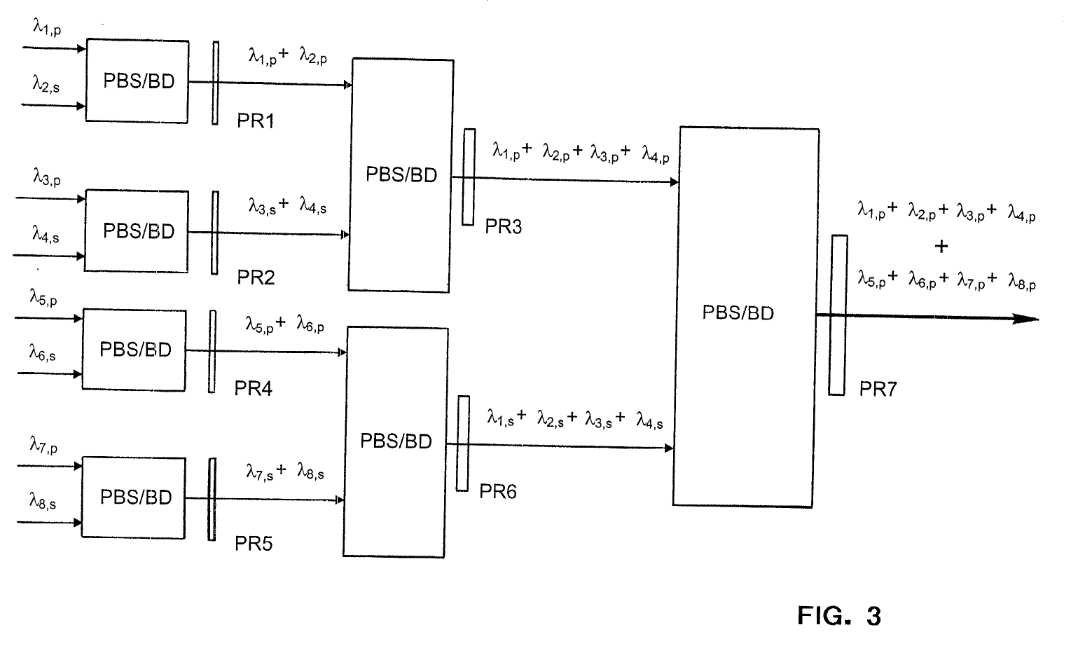

FIG. 3 shows a design with eight different wavelengths, which is comparable in its basic structure to the arrangement of FIG. 2;

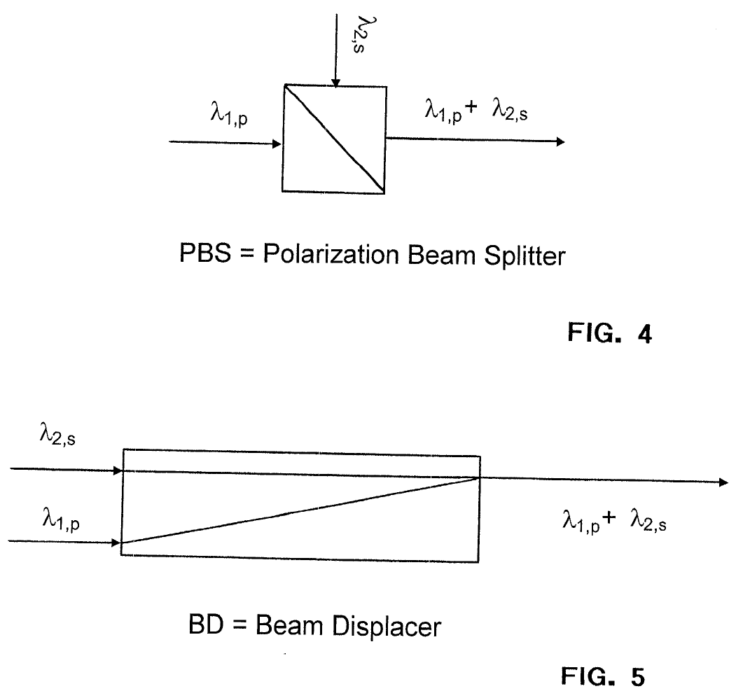

FIG. 4 shows a polarization beam splitter as a possible polarizing element that may be used, the illustration showing a multiplexing application;

FIG. 5 shows a beam displacer which may be used as a polarizing element, the illustration showing a multiplexing application;

FIG. 6 shows a polarization beam splitter as a possible polarizing element that may be used, the illustration showing a demultiplexing application;

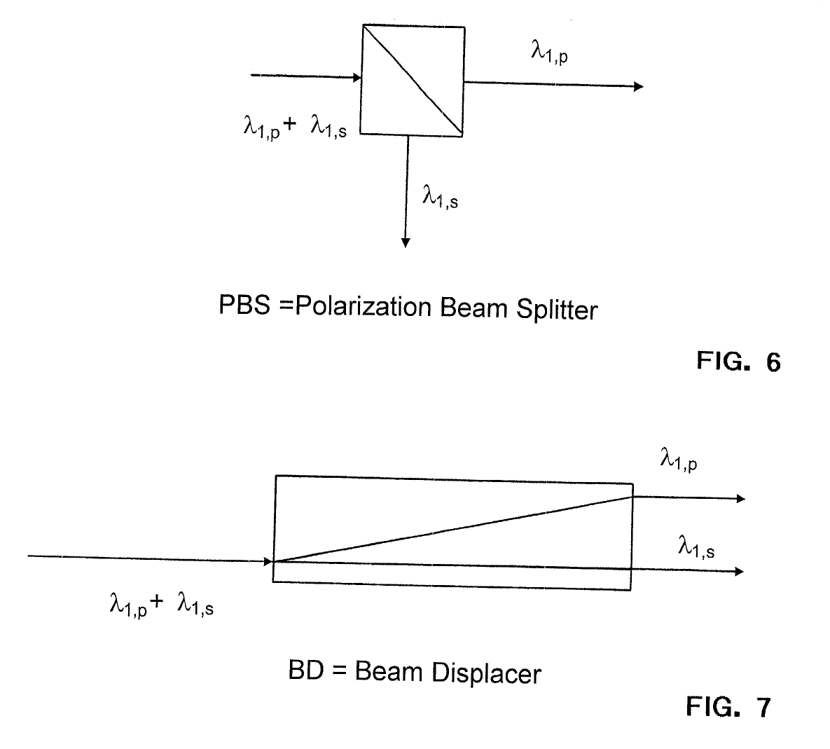

FIG. 7 shows a beam displacer which may be used as a polarizing element, the illustration showing a demultiplexing application;

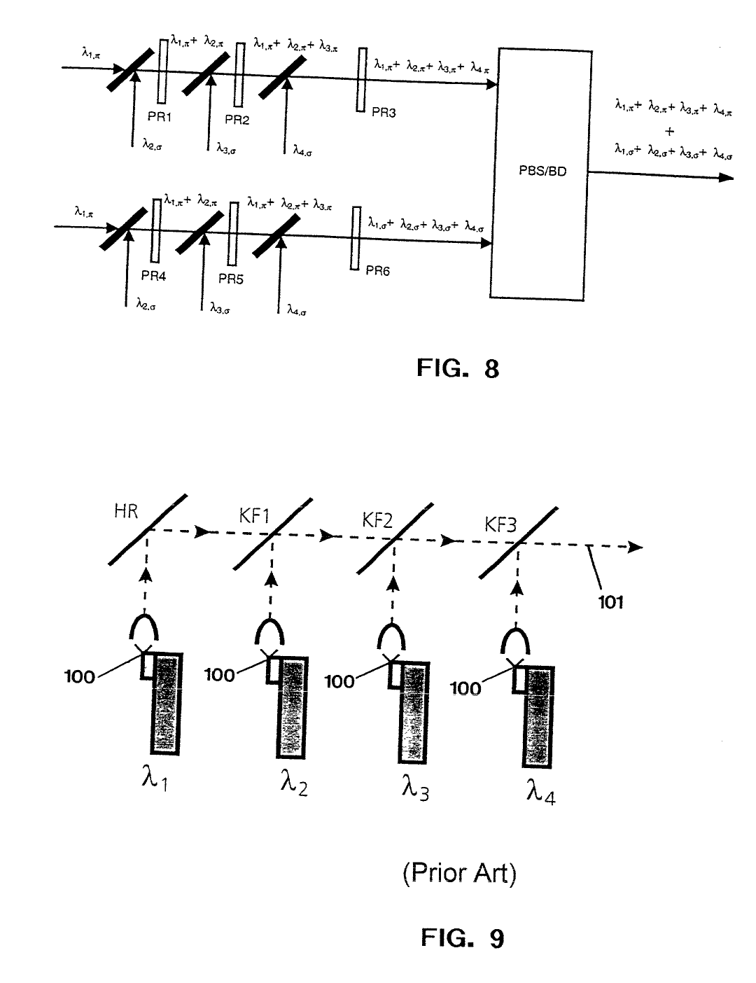

FIG. 8 shows an arrangement in which beams with narrow wavelength pitches are combined; and

FIG. 9 shows an arrangement according to the prior art.

In the schematically illustrated arrangement of FIG. 1 for wavelength multiplexing, four beams of different wavelengths λ₁, λ₂, λ₃, and λ₄ are combined. The two beams with the wavelengths λ₁ and λ₃ have a p- or π-polarization and the beams with the wavelengths λ₂ and λ₄ have an s- or σ-polarization. The beams with the wavelengths λ₁ and λ₂ are coaxially superposed by means of a polarization beam splitter, which is designated in the figures as PBS (polarization beam splitter), or by means of a beam displacer, which is designated in the drawings by BD (beam displacer). The radiation with the wavelengths λ₃ and λ₄ is combined by another polarization beam splitter or beam displacer PBS/BD. The combined beams with the wavelengths λ₁ and λ₂ pass through a wavelength plate PR1 (PR-phase retarder). The polarization of the beam with the wavelength λ₂ is rotated by 90°, whereas the polarization of the other beam passes through the wavelength plate PR1 in unchanged form. As a consequence, one obtains a combined beam λ_{1,p}+λ_{2,p}, i.e. the total beam is p-polarized. In parallel with this first partial arrangement the two other beams of the wavelengths λ₃ and λ₄ that are combined by the polarization beam splitter or beam displacer (PBS/BD) pass through the second wave plate PR2; the polarization of the beam with the wavelength λ₃ is rotated by 90°, whereas the polarization of the other beam remains unchanged. As a consequence, the beams with the wavelengths λ₃ and λ₄ are s-polarized, whereas the beams arising from the first combination with the wavelengths λ₁ and λ₂ are p-polarized. These two beams, in turn, can be coaxially combined with a polarization beam splitter (PBS) or a beam displacer (BD). Behind said element PBS/BD, a wave plate PR3 may be used that is dimensioned such that the polarization of the beams with the wavelengths λ₃+λ₄ is rotated by 90°, whereas the polarization of the two other beams λ₁+λ₂ passes therethrough in an unchanged form. This results in a total beam λ₁+λ₂+λ₃+λ₄ which is p- or π-polarized.

The arrangement as shown in FIG. 1 and described above has a cascade-like structure.

The arrangement of FIG. 1 can be doubled easily, as illustrated in FIG. 2. As for the lower radiation portions with the wavelengths λ₁, λ₂, λ₃ and λ₄, use is made—instead of the wave plate PR3 in the upper arrangement—of a wave plate PR4 that is designed such that the total beam after PR4 has the complementary s-polarization with respect to the total beam after PR3 with the p-polarization. The respective total beams λ_{1,p}+λ_{2,p}+λ_{3,p}+λ_{4,p} and λ_{1,s}+λ_{2,s}+λ_{3,s}+λ_{4,s} are then combined by a further polarizing element, again alternatively by a polarization beam splitter (PBS) or a beam displacer (BD), as shown in FIG. 2.

As can also be seen in FIG. 2, the arrangement can be extended in any desired way because of its cascade-like structure; in such a case a further stage must be added in succession with a respective doubling of the radiation portions to be superposed coaxially.

An arrangement with eight different wavelengths λ₁ to λ₈ can be seen in FIG. 3, the respective pairs of radiation which are p-polarized on the one hand and s-polarized on the other hand being coaxially superposed. The rotation of the polarization can be pursued by way of the indices used. At the output side of the arrangement, i.e. after the wave plate PR7, there are coaxially superposed beams λ_{1,p}+λ_{2,p}+λ_{3,p}+λ_{4,p} and λ_{5,p}+λ_{6,p}+λ_{7,p}+λ_{8,p}, i.e. the total beam is p-polarized.

As explained above, a beam displacer BD, a thin film polarizer, a polarization cube or also a Glan-Thomson prism (22) may, inter alia, be used as a polarization beam splitter. FIGS. 4 and 5 schematically show one example of a polarization cube and one of a beam displacer.

As shown in FIG. 5, in the beam displacer, the beams are radiated in parallel into the beam displacer with polarizations perpendicular to one another. As a consequence of the so-called walk-off effect, the beams of a different polarization propagate at different angles. Behind the exit surface all beams are again in parallel with one another. When the length of the beam displacer BD and the distances of the beams of a different polarization are matched, it is possible to combine all beams in coaxially superposed fashion after the beam displacer BD. A deflection is not necessary as in the case of a polarization beam splitter as shown in FIG. 4. Hence, the use of a beam displacer BD as compared to the use of a polarization beam splitter, shown in FIG. 4, realizes a multiplexing operation in a considerably easier way. A polarization beam splitter (PBS) and a beam displacer (BD) used for demultiplexing are shown in FIG. 6 and FIG. 7, respectively.

Strictly speaking, the walk-off angle, as explained above, depends on the wavelength because of dispersion. This has the effect that the offset depends on the wavelength. This dependence can be circumvented or avoided by a corresponding adjustment of the distance between the input beams.

All elements that can create a wavelength-selective change in polarization can be used as a wave plate. Examples thereof are Farahday rotator, double-refractive, plane-parallel plates, a pair of double-refractive wedge plates, waveguides that do not maintain the polarization, waveguides of double-refractive materials, liquid crystals (LC), or the like.

Depending on the use, it may also be of advantage to use the above-mentioned elements in an arrangement in combination with one another.

FIG. 8 shows a further arrangement which corresponds to the arrangement of FIG. 2 in the number of the respective wavelengths which are coaxially superposed. In this arrangement, however, polarization beam splitters PBS are used by way of example. Furthermore, the advantage is exploited that beams with high wavelength pitches are first coaxially combined with thin dielectric filters. The beams with narrow wavelength pitches are then combined via polarization beam splitters PBS, and a suitable wave plate, designated as PR1 to PR6, is used after each filter. This wave plate changes the beams in their s-polarization to a p-polarization, which means a high transmission.

As can be seen, the optical path in the arrangements is reversible. The reversal of the optical path results in arrangements for wavelength division or demultiplexing and in a wavelength selection.

1. Arrangement for multiplexing and/or demultiplexing at least two electromagnetic waves of different wavelengths λ₁, λ₂, characterized in that at least one polarizing element is used, the waves entering into said element in a linearly polarized manner.

2. The arrangement according to claim 1, characterized in that randomly polarized waves are divided by a polarizer into two linearly polarized waves prior to entry into said element.

3. The arrangement according to claim 1, characterized in that randomly polarized waves are divided by a beam displacer into two linearly polarized waves prior to entry into said element.

4. The arrangement according to claim 2 or claim 3, characterized in that said polarizer or said beam displacer is configured in the form of a waveguide.

5. The arrangement according to claim 4, characterized in that said polarizer or said beam displacer is configured in the form of a planar waveguide.

6. The arrangement according to claim 1, characterized in that elliptically polarized waves are transformed by a phase retarding plate into linearly polarized waves prior to entry into said element.

7. The arrangement according to claim 1, characterized in that elliptically polarized waves are transformed by a rotator into linearly polarized waves prior to entry into said element.

8. The arrangement according to claim 1, characterized in that said electromagnetic wave is an optical radiation.

9. The arrangement according to claim 1, characterized in that said polarizing element(s) is/are a polarization beam splitter.

10. The arrangement according to claim 1, characterized in that said polarizing element(s) is/are a beam displacer.

11. The arrangement according to claim 1, characterized in that said electromagnetic wave is guided by a waveguide to said element.

12. The arrangement according to claim 11, characterized in that said waveguide is dimensioned and designed such that said wave has a defined polarization at the exit end.

13. The arrangement according to claim 11 or 12, characterized in that a waveguide with a periodic grating structure or with an interferometric structure is used for said wavelengths as said polarizing element.

14. The arrangement according to claim 1, characterized in that a phase retarding plate is used after a polarizing element for changing the polarization state of at least one of said waves of a defined wavelength, the polarization states of the other waves of other wavelengths being substantially unchanged.

15. The arrangement according to claim 1, characterized in that for 3 to n waves of different wavelengths λ₁, λ₂, λ₃, λ₄, . . . λₙ N steps are provided with polarizing elements each arranged in cascade-like fashion one after the other,
where
N=1+log₂ n for n≠2^{N}
and
N=log₂ n for n=2^{N}.

16. The arrangement according to claim 1, characterized in that multiplexing and/or demultiplexing is/are carried out by at least one additional spectral filter.

17. The arrangement according to claim 1, characterized in that multiplexing and/or demultiplexing is/are carried out by at least one additional arrayed waveguide grating (AWG).
